(19) United States
(12) Patent Application Publication
(10) Pub. No.: US 2012/0196540 A1
(43) Pub. Date: Aug. 2, 2012

(54) METHOD AND APPARATUS FOR A BLUETOOTH-ENABLED HEADSET WITH A MULTITOUCH INTERFACE

(75) Inventor: Christopher E. Pearce, Dallas, TX (US)

(73) Assignee: CISCO TECHNOLOGY, INC., San Jose, CA (US)

(21) Appl. No.: 13/019,784

(22) Filed: Feb. 2, 2011

(51) Int. Cl. H04B 7/00

(52) U.S. Cl. 455/41.3

(57) ABSTRACT

In one embodiment, a method includes pairing an auxiliary device with a host device and controlling at least one function associated with the host device using a touch-sensitive interface of the host device. The touch-sensitive interface has a first axis and a second axis, and pairing the auxiliary device with the host device includes enabling the auxiliary device to communicate wirelessly with the host device. The at least one function is controlled by at least one gesture physically applied on the touch-sensitive interface along at least one of the first axis and the second axis.

The disclosure relates generally to wireless communications between host devices and associated peripherals, more particularly, to providing a multitouch interface on a peripheral that facilitates the control of a host device that is paired with the peripheral.

### BACKGROUND

Within telecommunications networks, Bluetooth-capable devices such as headsets are often used to provide a user with “hands-free” capability while utilizing a host device such as a telephone. For example, a user who is taking part in a phone call using a desk or cellular phone may use a Bluetooth headset in conjunction with the phone such that he or she may effectively utilize the cellular phone without holding the phone to his or her ear and mouth.

Many headsets include switches and/ or buttons that allow for the control of functions associated with the headsets and, hence, devices to which the headsets are paired. By way of example, a button on a Bluetooth headset may a user to answer a call received on a cell phone that is paired to the Bluetooth headset. Because switches and/or buttons on a headset generally may not be viewed by a user while the user is wearing the headset, it may often be difficult to actuate the switches and/or buttons. As such, headsets generally include only one or two buttons. Hence, very few functions of a headset and, hence, a device to which the headset is paired, may be activated or otherwise controlled through the use of switches and/or buttons.

Headsets also, in corporation with host devices, use voice or speech recognition capabilities to control functions associated with the host devices. As voice and speech recognition is often not reliable, controlling functions of host devices using voice or speech recognition is generally not desirable.

### BRIEF DESCRIPTION OF THE DRAWINGS

The disclosure will be readily understood by the following detailed description in conjunction with the accompanying drawings in which:

FIG. 1A is a block diagram representation of a host device that is wirelessly paired to a headset which includes a multitouch interface in accordance with an embodiment.

FIG. 1B is a block diagram representation of a telephone that is wirelessly paired to a headset which includes a multitouch interface in accordance with an embodiment.

FIG. 2 is a block diagram representation of a headset that includes a multitouch interface in accordance with an embodiment.

FIG. 3 is a diagrammatic representation of a headset, e.g., a Bluetooth headset, that includes a multitouch interface in accordance with an embodiment.

FIG. 4 is a process flow diagram which illustrates a method of utilizing a headset that includes a multitouch interface in accordance with an embodiment.

FIG. 5 is a process flow diagram which illustrates one method of processing actions sensed on a multitouch interface of a headset in accordance with an embodiment.

FIG. 6 is a process flow diagram which illustrates a method of configuring a headset that includes a programmable multitouch interface in accordance with an embodiment.

### DESCRIPTION OF EXAMPLE EMBODIMENTS

### General Overview

According to one aspect, a method includes pairing an auxiliary device with a host device and controlling at least one function associated with the host device using a touch-sensitive interface of the host device. The touch-sensitive interface has a first axis and a second axis, and pairing the auxiliary device with the host device includes enabling the auxiliary device to communicate wirelessly with the host device. The at least one function is controlled by at least one gesture physically applied on the touch-sensitive interface along at least one of the first axis and the second axis.

### Description

By including a multitouch interface on a headset that is arranged to be paired to a host device, the ability for a headset to be used to substantially control a host device may be enhanced. A multitouch interface implemented on a headset, e.g., a Bluetooth headset, that may be paired to a host device permits for the exposure of more functions than are generally exposed on a headset.

As will be appreciated by those skilled in the art, a multitouch interface enables a user to interact with a system with more than one finger at a time, and allows for actions to be detected. Actions may include, but are not limited to, gestures performed in contact with a multitouch interface such as finger swipes.

A multitouch interface, which may be a touch-sensitive screen or a touch-sensitive pad, may generally be easier to locate on a headset than a button. In addition, a multitouch interface on a headset may allow multiple functions of both the headset and a host device that is paired to the headset. Further, the ability to control functions using a multitouch interface may be more reliable than controlling functions using voice or speech recognition.

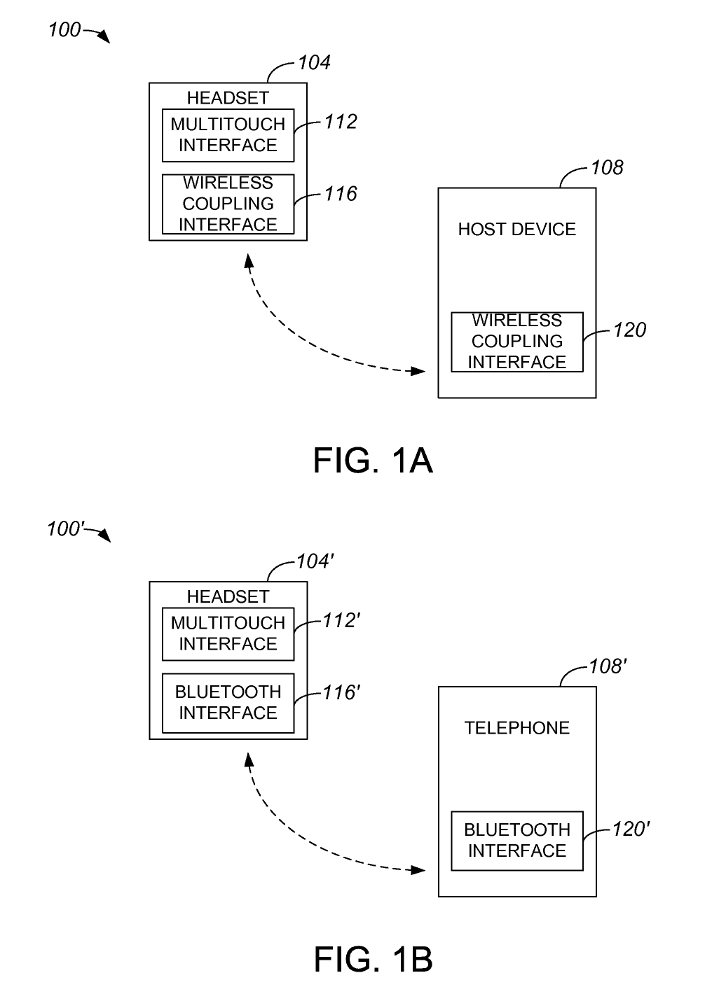

Referring initially to FIG. 1A, a headset with a multitouch interface will be described in accordance with an embodiment. FIG. 1A is a block diagram representation of a host device that is wirelessly paired to a headset which includes a multitouch interface. A host device 108 includes a wireless coupling interface 120. Host device 108 is paired with a headset 104 such that host device 108 and headset 104 may communicate with each other. A wireless communications link may be established between host device 108 and headset 104 using wireless coupling interface 120 of host device 108 and a wireless coupling interface 116 of headset 104.

Headset 104 includes a multitouch interface 112, e.g., a surface that is capable of sensing multiple touch points on the surface substantially simultaneously. Multitouch interface 112 is arranged to detect and to resolve touch including, but not including, single touch events and gesture events. In one embodiment, multitouch interface 112 is also capable of tracking touch events and gesture events.

Multitouch interface 112 may be a pressure-sensitive interface or a force-sensitive interface. By way of example, multitouch interface 112 may be a multitouch screen or a multitouch pad.

In one embodiment, a host device such as host device 108 may be a telephone that communicates with a headset using Bluetooth communications. FIG. 1B is a block diagram representation of a telephone that engages in Bluetooth communications with a headset which includes a multitouch interface in accordance with an embodiment. A telephone 108′ may be any suitable telephone including, but not limited to including, a voice over internet protocol (VoIP) telephone, a desktop telephone, and a cellular telephone. Telephone 108′ includes a Bluetooth interface 120′ that is configured to enable telephone 108′ to pair with a headset 104′ that includes a Bluetooth interface 116′. Once paired, telephone 108′ and headset 104′ may engage in Bluetooth communications.

Headset 104′ includes a multitouch interface 112 that is configured to arrange functions associated with headset 104′ and with telephone 108′ to be accessed and controlled. It should be appreciated that touches, as for example gestures, that are detected by multitouch interface 112 may be resolved and/or provided to telephone 108′ using Bluetooth communications.

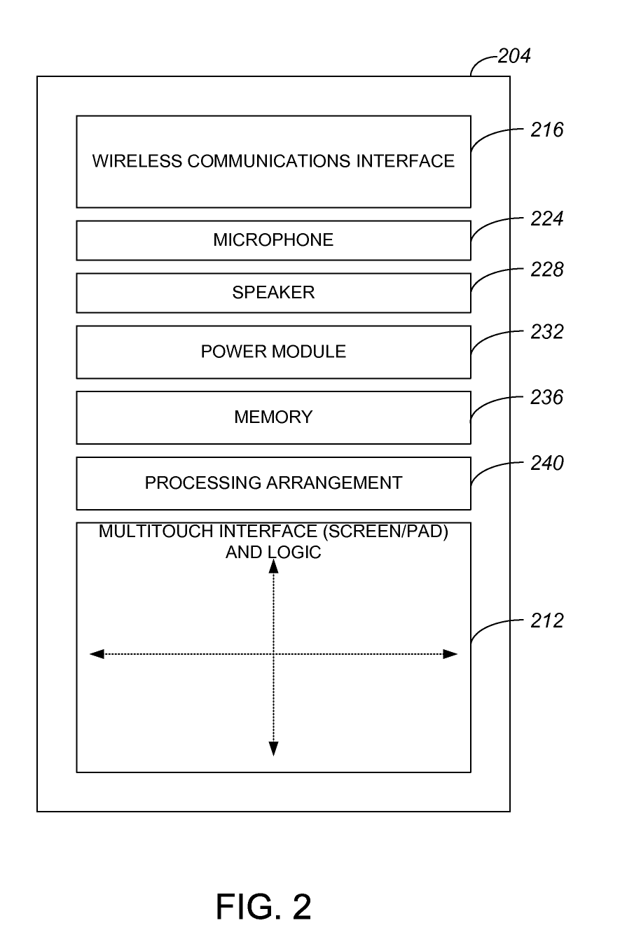

With reference to FIG. 2, a headset that includes a multitouch interface will be described in accordance with an embodiment. A headset 204 is configured to be paired with substantially any device that may engage in wireless communications, e.g., Bluetooth communications. Headset 204 includes multitouch interface and logic block 212. Block 212 includes a multitouch interface such as a touch-sensitive screen or a touch-sensitive pad that is arranged to substantially obtain input from a user in the form of at least one touch or gesture. Block 212 also includes logic that may process, as for example detect and/or resolve, the obtained input.

Headset 204 also includes a wireless communications interface 215, a memory 236, and a processing arrangement 240. A wireless communications interface 216 is configured to enable headset 204 to pair with a host device (not shown), and to engage in wireless communications with the host device. Memory 236 is arranged to store information that may be used by wireless communications interface 216 and block 212, for example. Information stored in memory 236 may include, but is not limited to including, information relating to functions that may be accessed through a multitouch interface and information associated with establishing wireless communications using wireless communications interface 216. Processing arrangement 240 facilitates the execution of logic, e.g., software logic, that may generally be associated with headset 204. For instance, processing arrangement 240 may facilitate the execution of any software logic that is associated with block 212.

In general, headset 204 also includes a microphone 224, a speaker 228, and a power module. Microphone 224 allows anything spoken by a user to be sensed and provided, for example, to a host device (not shown). Speaker 228 generally allows a user to hear communications received through wireless communications interface 216. Power module 232 is generally arranged to provide power to headset 204 and may include, but is not limited to including, an interface to a power cord (not shown) and/or a battery.

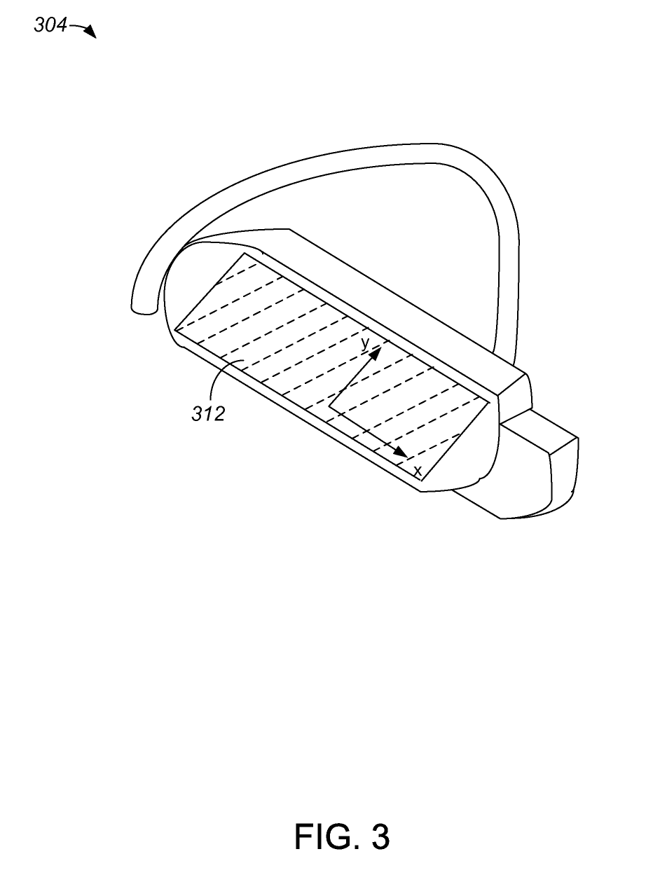

A headset may be substantially any device that is arranged to enable a user to receive audio communications and to send or otherwise provide audio communications. FIG. 3 is a diagrammatic representation of a headset, e.g., a Bluetooth headset, that includes a multitouch interface in accordance with an embodiment. A headset 304 is arranged to wireless pair with a host device (not shown) such as a telephone. A multitouch interface 312 is located on an exterior surface of headset 304 such that interface 312 is accessible, e.g., to the digits of a user, while the user is wearing headset 304. Interface 312 may generally be any suitable interface which is configured to sense, e.g., to detect and to resolve, touch such as contact from fingers, fingernails, and/or styluses. Interface 312 may be, but is not limited to being, a digital resistive interface or a capacitance-based interface. In one embodiment, interface 312 may be a touch-sensitive screen that includes a visual display. That is, interface 312 may be a touchscreen. In another embodiment, interface 312 may be a touchpad, or a touch-sensitive pad that does not include a visual display.

Interface 312 is arranged such that gestures, as for example swiping or pinching gestures, made along an x-axis and/or a y-axis may cause functions to be activated or controlled. For example, a swiping gesture performed on interface 312 along an x-axis in one direction may cause a volume associated with a phone call to increase, while a swiping gesture along the x-axis in another direction may cause the volume associated with the phone call to decrease. Alternatively, a pinching gesture in which two digits are in contact with interface 312 and the digits are moved towards each other along an axis or are moved away from each other along the axis, may be used to increase volume and to decrease volume. By way of example, a pinching gesture in which digits are moved towards each other along an x-axis of interface 312 may cause a volume associated with a phone call to be decreased, while a pinching gesture in which digits are moved apart along the x-axis away from each other may cause the volume to be increased.

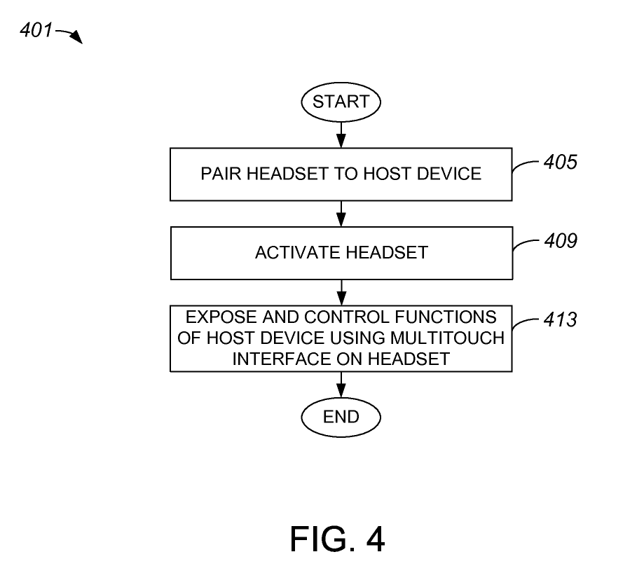

With reference to FIG. 4, a method for utilizing a headset that includes a multitouch interface will be described in accordance with an embodiment. A process 401 of utilizing a headset that includes a multitouch interface begins at step 405 in which the headset is paired to a host device, e.g., a telephone such as a desktop phone or a cellular phone. Pairing of a headset to a host device may occur using any suitable method that allows both the headset and the host device to effectively recognize that the headset and the host device are to communicate with each other and to establish a connection. For example, to pair a Bluetooth headset to a host device that supports Bluetooth, a password may be exchanged between the Bluetooth headset and the host device.

Once a headset is paired to a host device, the headset may be activated in step 409. Activating the headset may include, but is not limited to including, essentially powering on the headset to initiate a phone call and answering a phone call. After the headset is activated, functions of the host device may effectively be exposed and controlled in step 413 using the multitouch interface on the headset. Exposing functions generally involves allowing the functions to be controlled. For example, exposing a volume control function on the multitouch interface allows a user of the headset to interact with the multitouch interface to control the volume. Upon exposing functions and allowing functions to be controlled using the multitouch interface, the method for utilizing a headset is completed.

In general, a headset that includes a multitouch interface senses or, more generally, obtains commands from a user through the multitouch interface. That is, actions taken by a user with respect to a multitouch interface of a headset essentially translate into commands that are to be processed. The headset may be arranged to process the commands. Alternatively, the headset may be arranged to communicate the commands to a host device which then processes the commands.

A sequence of touches, e.g., gestures, performed on a multitouch interface of a headset may be used to access a particular function, and may result in the exposure of at least one menu prior to activating the particular function. It should be appreciated that a menu generally provides for the selection of different functions and/or menus to activate. Typically, when a multitouch interface is configured as a menu, depending upon where on the multitouch interface a gesture is made and/or the type of gesture that is made, a different function may be activated. In one embodiment, a first gesture made on a multitouch interface at a first level may expose or otherwise activate a menu at a second level. In such an embodiment, depending on the type of gesture or the location of the gesture made with respect to the menu at the second level, a function may be activated. For example, to change the volume associated with a phone call, a user may need to navigate through a series of nested menus using a multitouch interface until he or she may select a volume control feature and, subsequently, change the volume associated with the phone call.

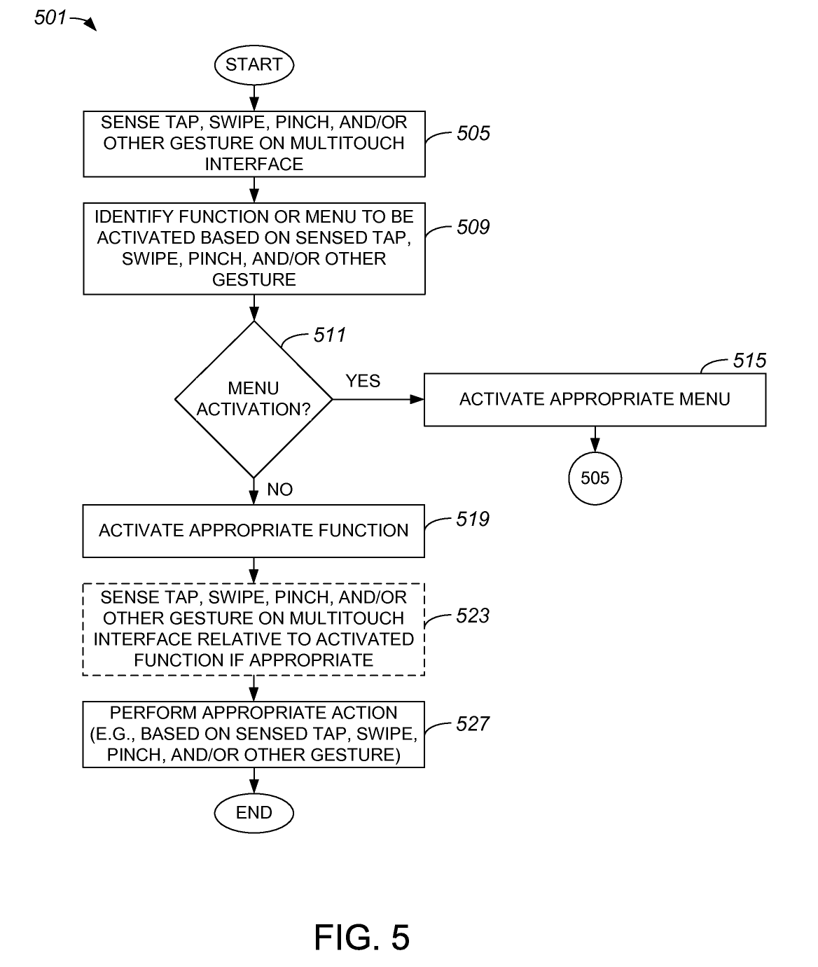

FIG. 5 is a process flow diagram which illustrates one method of processing actions sensed on a multitouch interface of a headset in accordance with an embodiment. A method 501 of processing actions begins at step 505 in which a headset effectively senses a gesture made on a multitouch interface. The gesture may generally be a tap, a swipe, a pinch, and/or other gesture that is physically made on a multitouch interface such as a touchscreen or a touch pad. Gestures are typically made using the digits, i.e., thumb and/or fingers, of a user. It should be appreciated, however, that gestures may also be made on a multitouch interface using the fingernails of a user or using a stylus.

Once a gesture made on the multitouch interface is sensed, a function or menu that is to be activated based on the sensed gesture is identified in step 509. Identifying a function or a menu to be activated may include, but is not limited to including, determining where on a multitouch interface a gesture was performed, determining the speed at which the gesture was performed, and determining the directionality associated with a gesture that is a swipe or a pinch.

A determination is made in step 511 as to whether the gesture sensed in step 505 corresponds to the activation of a menu. In other words, a determination is made regarding whether a request to activate a menu has effectively been received. If it is determined that a menu is to be activated, then process flow moves to step 515 in which an appropriate menu, i.e., the menu identified in step 509, is activated. Activating a menu may include effectively setting, or otherwise configuring, the multitouch interface to anticipate a particular set of gestures. After the appropriate menu is activated, process flow returns to step 505 in which another gesture is sensed on the multitouch interface.

Alternatively, if the determination in step 511 is that the activation of a menu has not been requested, the indication is that a request to activate a particular function has been obtained. Accordingly, in step 519, an appropriate function is activated. Once the appropriate function is activated, in an optional step 523, a gesture that relates to the activated function may be sensed if appropriate. For example, if the function activated in step 519 is a volume control function, a gesture that relates to increasing the volume associated with a phone call or decreasing the volume associated with a phone call may be sensed in step 523, and the volume of the phone call may be changed in step 527. In general, after an appropriate action is performed in step 527, the method of processing actions is completed.

Typically, if activating the appropriate function in step 519 effectively does not necessitate sensing an additional gesture, step 523 may effectively be bypassed. For example, if the function activated in step 519 is related to terminating a phone call, then no other gesture relating to terminating the phone call is generally needed to cause the phone call to be terminated. Thus, no gesture would effectively need to be sensed in step 523, and the phone call may be terminated in step 527.

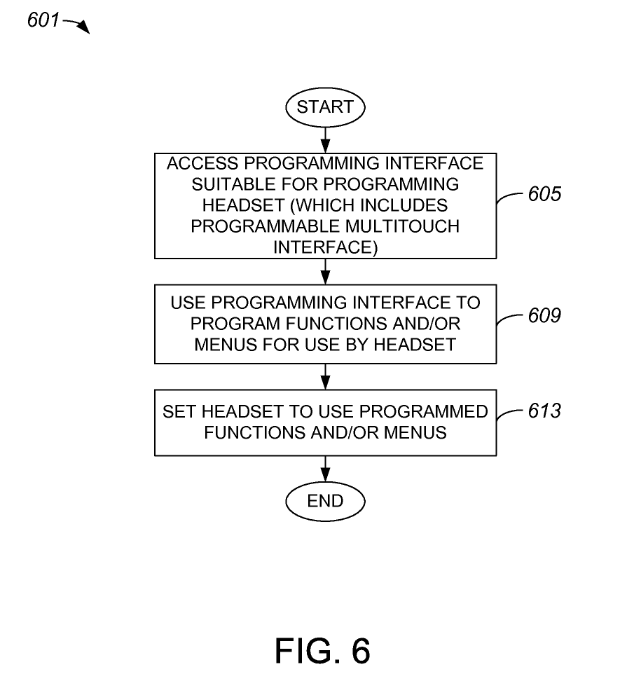

A headset that includes a multitouch interface may be such that a user may configure features or functions that may be substantially controlled through the multitouch interface. In other words, a multitouch interface may be a programmable interface, and a user may configure the multitouch interface based upon his or her personal preferences. FIG. 6 is a process flow diagram which illustrates a method of configuring a headset that includes a programmable multitouch interface in accordance with an embodiment. A method 601 of configuring a programmable multitouch interface of a headset begins at step 605 in which a programming interface that is suitable from programming the headset is accessed. Such a programming interface may be located on a headset, on a host device that is paired to the headset, and/or on a computing system that has access to the headset and/or the host device.

In step 609, the programming interface is used to program functions and/or menus that are to be associated with the multitouch interface of the headset. Once the functions and/or menus are programmed, the headset is set in step 613 to use the programmed functions and/or menus. That is, the headset is configured based upon the functions and/or menus programmed in step 609. The method of configuring a programmable multitouch interface is completed after the headset is configured to use programmed functions and/or menus.

Although only a few embodiments have been described in this disclosure, it should be understood that the disclosure may be embodied in many other specific forms without departing from the spirit or the scope of the present disclosure. By way of example, a headset has been described as a Bluetooth headset, and communications between a headset and a host device has been described as Bluetooth communications. In general, a headset may be any headset that is configured to communicate wirelessly with a host device, and the communications between the headset and the host device are not limited to being Bluetooth communications. That is, a headset and a host device may communicate using any suitable wireless technology.

A headset may include any number of multitouch interfaces. By way of example, a headset may include separate multitouch interfaces for each set of functions. In one embodiment, a headset may include one multitouch interface that is used to substantially control user interface features such as volume, and another multitouch interface that is used to substantially handle calls. A multitouch interface that is used to substantially handle calls may be used to, but is not limited to being used to, answer calls, end calls, place calls on hold, transfer calls, dust calls, and/or facilitate conference calls.

The location of a multitouch interface on a headset may vary. In general, a multitouch interface may be positioned on substantially any portion of a headset that is accessible when a user is wearing the headset.

A headset that includes a multitouch interface may also include other control mechanisms, e.g., buttons and/or switches, without departing from the spirit or the scope of the present disclosure.

Programming a multitouch interface may generally include allowing a user to define functions he or she wishes to have the ability to control through the multitouch interface. It should be appreciated that such programming entail, in one embodiment, allowing a user to select functions from a set of predefined functions. Further, programming a multitouch interface may also involve defining a sequence of touches or gestures that a user wishes to use to activate a particular function. Such a sequence of touches or gestures may include consecutive touches or gestures as well as substantially simultaneous touches or gestures, e.g., touching two different areas of a multitouch interface substantially simultaneously may activate a particular menu or function.

The number of menus and the number of functions accessible on a multitouch interface may vary widely depending upon factors including, but not limited to including, the size of the multitouch interface and the sensitivity associated with the multitouch interface. In general, single-finger swipes that are in either direction across a longitudinal axis such may activate different functions, and single finger swipes in either direction across a lateral axis may activate other functions. Double-finger swipes may double the number of functions that may be associated with a multitouch interface.

A headset has generally been described as including logic that supports a multitouch interface and logic that supports a wireless communications interface. It should be appreciated that a headset is not limited to including logic that supports a multitouch interface and logic that supports a wireless communications interface. By way of example, a headset may also include logic that supports functions such as voice or speech recognition, muting, and other functions that are typically associated with the use of a telephone.

The embodiments may be implemented as hardware and/or software logic embodied in a tangible medium that, when executed, e.g., by a processing system associated with a host device and/or a headset, is operable to perform the various methods and processes described above. That is, the logic may be embodied as physical arrangements, modules, or components. A tangible medium may be substantially any suitable physical, computer-readable medium that is capable of storing logic which may be executed, e.g., by a processing system such as a computer system, to perform methods and functions associated with the embodiments. Such computer-readable media may include, but are not limited to including, physical storage and/or memory devices. Executable logic may include code devices, computer program code, and/or executable computer commands or instructions that may be embodied on computer-readable media.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
pairing an auxiliary device with a host device, the auxiliary device including a touch-sensitive interface having a first axis and a second axis, wherein pairing the auxiliary device with the host device includes enabling the auxiliary device to communicate wirelessly with the host device; and
controlling at least one function associated with the host device using the touch-sensitive interface, wherein the at least one function is controlled by at least one gesture physically applied on the touch-sensitive interface along at least one of the first axis and the second axis.

2. The method of claim 1 wherein the auxiliary device is arranged to communicate wirelessly with the host device using Bluetooth communications.

3. The method of claim 2 wherein the host device has phone capabilities and the auxiliary device is a headset.

4. The method of claim 3 wherein the host device is a cellular phone.

5. The method of claim 1 wherein the at least one function is one selected from a group including a volume function, an on/off function, a muting function, a call connect function, and a call disconnect function

6. The method of claim 1 wherein the at least one gesture is a finger swipe gesture.

7. The method of claim 1 wherein the at least one function includes a first function and a second function, and wherein the first function is controlled by a first swipe gesture applied on the touch-sensitive interface along the first axis and the second function is controlled by a second swipe gesture applied on the touch-sensitive interface along the second axis.

8. The method of claim 7 wherein the at least one function further includes a third function, and wherein the third function is controlled by a tap gesture applied on the touch-sensitive interface.

9. The method of claim 1 wherein the touch-sensitive interface is a touch screen.

10. The method of claim 1 wherein the touch-sensitive interface is a touch pad.

11. The method of claim 1 wherein the at least one function is further controlled by at least one pinch gesture applied on the touch-sensitive interface along at least one of the first axis and the second axis.

12. An apparatus comprising:
means for receiving input, the means for receiving input including a first axis and a second axis, the means for receiving input being arranged to sense a gesture along at least one of the first axis and the second axis;
an interface, the interface suitable for pairing with a host device to enable wireless communications with the host device; and
means for controlling at least one function associated with the host device using the input.

13. The apparatus of claim 12 wherein the apparatus is a Bluetooth headset, and wherein the interface is a Bluetooth interface suitable for pairing with the host device to enable Bluetooth communications with the host device.

14. A computer-readable medium comprising computer program code, the computer program code, when executed, configured to:
pair an auxiliary device with a host device, the auxiliary device including a touch-sensitive interface having a first axis and a second axis, wherein the computer program code configured to pair the auxiliary device with the host device is further configured to enable the auxiliary device to communicate wirelessly with the host device; and
control at least one function associated with the host device using the touch-sensitive interface, wherein the at least one function is controlled by at least one gesture physically applied on the touch-sensitive interface along at least one of the first axis and the second axis.

15. The computer-readable medium of claim 14 wherein the auxiliary device is arranged to communicate wirelessly with the host device using Bluetooth communications.

16. The computer-readable medium of claim 15 wherein the host device has phone capabilities and the auxiliary device is a headset.

17. The computer-readable medium of claim 16 wherein the host device is a cellular phone.

18. The computer-readable medium of claim 14 wherein the at least one function is one selected from a group including a volume function, an on/off function, a muting function, a call connect function, and a call disconnect function

19. The computer-readable medium of claim 14 wherein the at least one gesture is a finger swipe gesture.

20. The computer-readable medium of claim 14 wherein the at least one function includes a first function and a second function, and wherein the first function is controlled by a first swipe gesture applied on the touch-sensitive interface along the first axis and the second function is controlled by a second swipe gesture applied on the touch-sensitive interface along the second axis.

21. An apparatus comprising:
a wireless communications interface, the wireless communications interface being arranged to establish wireless communications with a host device;
a multitouch module, the multitouch module including a multitouch interface having a plurality of axes, the multitouch interface being arranged to sense at least one gesture applied along at least one axis selected from the plurality of axes, and the second axis, the multitouch module further including multitouch logic, wherein the multitouch logic is arranged to process the at least one gesture and to activate a function that corresponds to the at least one gesture; and
a processing arrangement, the processing arrangement being arranged to support the wireless communications interface and the multitouch module.

22. The apparatus of claim 21 wherein the function is associated with the host device, and wherein the multitouch logic is arranged to cooperate with the wireless communications interface to activate the function associated with the host device.

23. The apparatus of claim 21 wherein the multitouch interface is one selected from the group including a touch-sensitive screen and a touch-sensitive pad.

24. The apparatus of claim 21 wherein the apparatus is a headset and the host device includes telephone capabilities.

25. The apparatus of claim 24 wherein the headset is a Bluetooth headset and the host device is a Bluetooth-capable telephone, and wherein the wireless communications interface is arranged to establish Bluetooth communications with the host device.
